(19) United States
(12) Patent Application Publication
(10) Pub. No.: US 2007/0050111 A1
(43) Pub. Date: Mar. 1, 2007

(54) Method and apparatus for automated positioning of user support surfaces in power driven wheelchair

(75) Inventors: John Mattes, Columbia Station, OH (US); Bruce A. Jaenke, Parma, OH (US); Gary E. Chopcinski, North Ridgeville, OH (US)

Correspondence Address: CALFEE HALTER & GRISWOLD, LLP, 800 SUPERIOR AVENUE, SUITE 1400, CLEVELAND, OH, 44114, US

(73) Assignee: Invacare Corp.

(21) Appl. No.: 11/513,746

(22) Filed: Aug. 31, 2006

Related U.S. Application Data
(60) Provisional application No. 60/712,987, filed on Aug. 31, 2005.
(60) Provisional application No. 60/727,249, filed on Oct. 15, 2005.

(51) Int. Cl. G06F 7/00

(52) U.S. Cl. 701/36

(57) ABSTRACT

By programming position parameters corresponding to user support surfaces of a power driven wheelchair, movement of the user support surfaces is automated. The user support surfaces can be positioned individually, as part of a sequence or as part of a series of sequences. Accordingly, with little effort, a user can position the user support surfaces of the wheelchair to a predefined position.

### RELATED APPLICATION

The present application is being filed as a non-provisional patent application claiming priority under 35 U.S.C. § 119(e) from, and any other benefit of, U.S. Provisional Patent Application No. 60/712,987 entitled System And Method For Controlling A Wheelchair and filed on Aug. 31, 2005 (Attorney Docket No. 12873.05174); and U.S. Provisional Patent Application No. 60/727,249 entitled Method And Apparatus For Automated Positioning Of User Support Surfaces In Power Driven Wheelchair and filed on Oct. 15, 2005 (Attorney Docket No. 12873.05248), which are hereby incorporated by reference.

### BACKGROUND

It is well known that physically impaired individuals with such disabilities as spinal cord injury, muscular dystrophy, multiple sclerosis, cerebral palsy or arthritis need the assistance of a power driven wheelchair to be mobile. Power driven wheelchairs, which may be of the type manufactured by Invacare Corporation of Elyria, Ohio, for example, generally include right and left side drive wheels driven by a motor controller via respectively corresponding right and left side drive motors, all of which are disposed on the wheelchair. A user can control, for example, the speed and direction of movement of the wheelchair, by manipulating a controller.

Power driven wheelchairs are generally controlled by an electronic control system. An exemplary control system for power or motor driven wheelchairs is disclosed in U.S. Pat. No. 6,819,981, entitled “Method and Apparatus for Setting Speed/Response Performance Parameters of a Power Driven Wheelchair,” issued Nov. 16, 2004, and assigned to the same assignee as the instant application, which patent is hereby incorporated by reference in its entirety.

Typically, the power driven wheelchairs have a plurality of drive settings corresponding to different types of operation of the wheelchair by the user. An exemplary wheelchair may include four drive settings which may be Drive 1 (D1) for indoor operation, Drive 2 (D2) for moderate outdoor operation, Drive 3 (D3) for special operation, and Drive 4 (D4) for ramps and curbs. For each drive setting, there are numerous performance and power seating parameters which are programmed into the control system to satisfy the operational capabilities of the individual user of the wheelchair. The programming task is normally conducted through a hand held programmer unit having an interactive display and coupled to the control system much as described in the above-referenced U.S. Pat. No. 6,819,981, for example.

Additionally, power driven wheelchairs generally include user support surfaces for supporting a user while in the wheelchair. For example, a seat mounted on the wheelchair forms a user support surface for the user to sit on. A seat back forms a user support surface for the user's back. A pair of arms and a pair of legs may be mounted on the wheelchair to form user support surfaces for the user's arms and legs, respectively.

The position of these user support surfaces can be adjusted to increase the user's comfort. For example, by manually moving the aforementioned controller, the user can adjust the angle of the seat back relative to the seat based on the user's preference. The user must, however, continue to manipulate the controller to place a user support surface in a position desired by the user. Furthermore, the user must again manipulate the controller when changing the user support surface from one position to another. Additionally, the user is required to remember, or rediscover each time, the ideal position of the user support surfaces for performing a particular task. Thus, changing the position of the user support surfaces is often time-consuming and inconvenient to the user.

### SUMMARY

In an exemplary aspect, a system and method are provided for programming automatic positioning (AP) information for a user support surface of a wheelchair.

According to another exemplary aspect, a system and method are provided for automating the positioning of a support surface of a wheelchair.

According to yet another exemplary aspect, a system and method are provided for programming automatic sequence positioning (ASP) information for sequentially positioning a plurality of user support surfaces of a wheelchair.

According to another exemplary aspect, a system and method are provided for automatically changing the positioning of a specified sequence of user support surfaces of a wheelchair.

According to still another exemplary aspect, a system and method are provided for programming automatic sequence positioning series (ASPS) information for a specified series of positioning sequences of user support surfaces of a wheelchair.

According to another exemplary aspect, a system and method are provided for automatically changing the positioning of a specified series of sequences of user support surfaces of a wheelchair. It is an additional exemplary aspect to automatically change the positioning of user support surfaces of a wheelchair according to a specified series of positioning sequences, wherein the sequences are separated by a predetermined period of time and user confirmation is required between the sequences.

### BRIEF DESCRIPTION OF THE DRAWINGS

The above aspects and additional aspects, features and advantages will become more apparent by describing in detail exemplary embodiments thereof with reference to the attached drawings, in which:

FIG. 1 is a perspective view of a power driven wheelchair, applicable to exemplary embodiments;

FIG. 2 is a schematic diagram illustrating a plurality of actuators connected to a controller of a power driven wheelchair, according to an exemplary embodiment;

FIG. 3 is a schematic diagram illustrating exemplary actuator parameters residing in a memory for different drive settings;

FIG. 4 is a schematic diagram illustrating additional exemplary actuator parameters residing in a memory for different drive settings;

FIG. 5 is a schematic diagram illustrating multiple exemplary position parameters residing in a memory for respective actuators;

FIG. 6 is a schematic diagram illustrating a programming device connected to a control system of a power driven wheelchair, according to an exemplary embodiment;

FIG. 7 is a flowchart illustrating a method of programming position parameters into a memory, according to an exemplary embodiment;

FIGS. 8A-8C are schematic diagrams illustrating a graphic interface for inputting parameter values, according to an exemplary embodiment;

FIG. 9 is a flowchart illustrating a method of automatically moving a user support surface of a wheelchair to a predefined position, according to an exemplary embodiment;

FIG. 10 is a flowchart illustrating a method of programming a sequence of position parameters into a memory, according to an exemplary embodiment;

FIG. 11 is a schematic diagram illustrating sequences of position parameters for a drive setting, as stored in a memory, according to an exemplary embodiment;

FIG. 12 is a flowchart illustrating a method of automatically positioning user support surfaces of a wheelchair in a predefined sequence, according to an exemplary embodiment;

FIG. 13 is a flowchart illustrating a method of programming position parameters for an automatic sequence positioning series (ASPS) into a memory, according to an exemplary embodiment;

FIG. 14 is a schematic diagram illustrating a series of sequences of position parameters for a drive setting stored, as stored in a memory, according to an exemplary embodiment;

FIG. 15 is a flowchart illustrating a method of automatically positioning user support surfaces of a wheelchair through a series of predefined sequences, according to an exemplary embodiment; and

FIG. 16 is a flowchart illustrating a method of automatically positioning user support surfaces of a wheelchair through a series of predefined sequences, according to another exemplary embodiment.

### DETAILED DESCRIPTION OF EXEMPLARY EMBODIMENTS

As described herein, the adjustment of user support surfaces (e.g., a seat, an armrest, etc.) of a power driven wheelchair is simplified and enhanced. Data representing a desired position of a user support surface is stored in advance. Thereafter, through a simple action (e.g., moving a joystick in a particular direction, such as pressing the joystick to its “up” position), the user can cause the data to be retrieved and used to automatically move the corresponding user support surface to the position defined by the data.

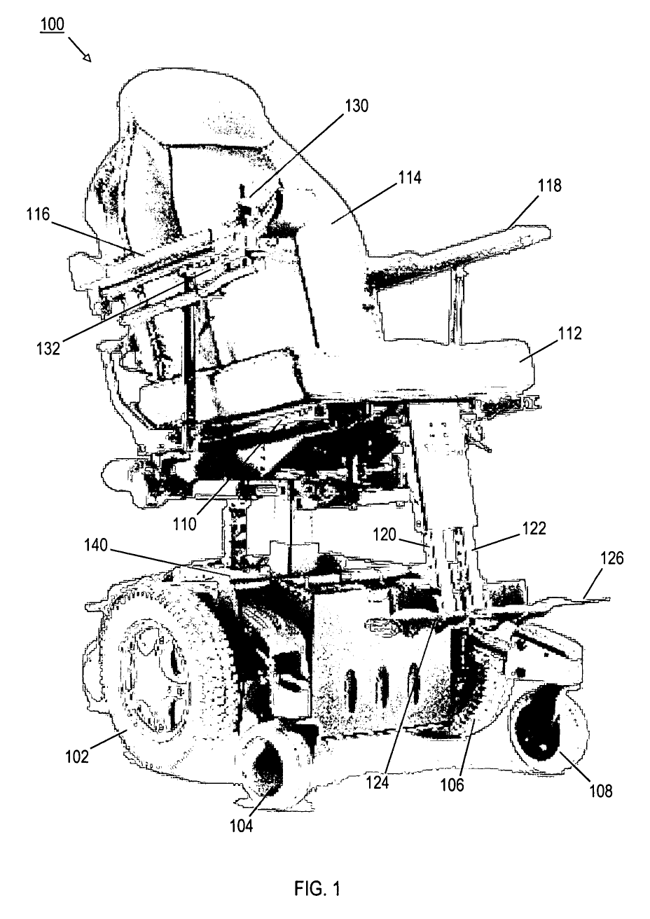

An exemplary power driven wheelchair is illustrated in FIG. 1. Referring to FIG. 1, the power driven wheelchair 100 includes a right wheel 102, a right caster 104, a left wheel 106 and a left caster 108. The wheels and casters are connected to a chassis 140 of the wheelchair. The wheelchair may be powered by one or more batteries, D.C. current or any other alternative power source, which is capable of operating the wheelchair. An optional battery compartment (not shown) for housing one or more batteries can be provided in the chassis 140, but any other element can be used to locate the batteries on the wheelchair. Any type of motor or motors (not shown) can be employed to drive one or more wheels of the wheelchair. Examples of such motors commonly used in the art can be classified as d.c. gear motors, brushless gear motors, or brushless gearless motors. Different types of wheel drives, for example, front-wheel drive, mid-wheel-drive, rear-wheel drive, all-wheel drive, or four-wheel drive, can also be used.

The wheelchair 100 generally includes a seat frame 110 upon which a seat 112 is mounted. The seat includes a seat back 114. Additionally, the wheelchair may include a right arm 116, a left arm 118, a right leg 120, and a left leg 122. The arms 116, 118 and the legs 120, 122 may be connected to the seat frame 110. The right leg 120 and the left leg 122 may include a right footrest 124 and a left footrest 126, respectively. The footrests 124, 126 may be formed so as to move independently of the respective legs 120, 122.

Each of the seat 112, the seat back 114, the right arm 116, the left arm 118, the right leg 120, the left leg 122, the right footrest 124 and the left footrest 126 forms a user support surface capable of supporting some portion of a user's body. For example, the right arm 116 forms a user support surface upon which a user may place his or her right arm.

The wheelchair 100 may further include a controller 130 for controlling, for example, the speed and direction of movement of the wheelchair 100. The controller 130 may be mounted on the wheelchair 100 via a mounting assembly 132. In the exemplary embodiment of FIG. 1, the controller 130 is a joystick. However, other types of controllers of can be used. For example, touchpad controllers, sip and puff controllers, headset controllers, etc. (not shown) can be used to control operation of the wheelchair 100.

Additionally, the controller 130 (or some other control mechanism mounted to the wheelchair 100) can be used to cause an actuator to move one or more of the aforementioned user support surfaces. A user support surface may be operable to move in one or more directions via one or more actuators.

With regard to the exemplary power driven wheelchair 100, illustrated in FIG. 1, it should be appreciated that different designs and embodiments, such as wheel sizes and locations may be utilized and the drawing is merely an example of one type of wheelchair to which the embodiments may be applied.

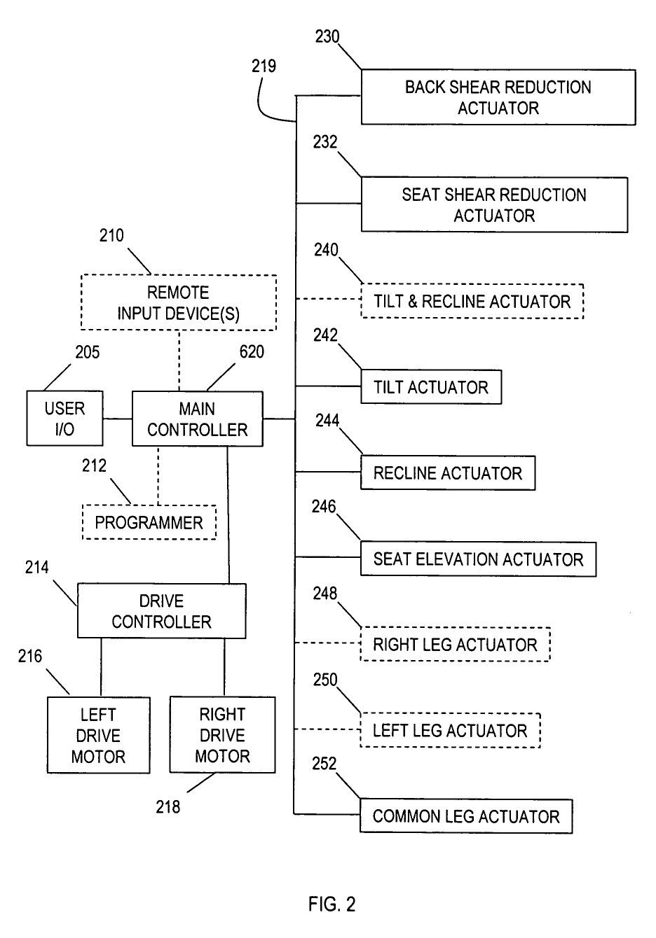

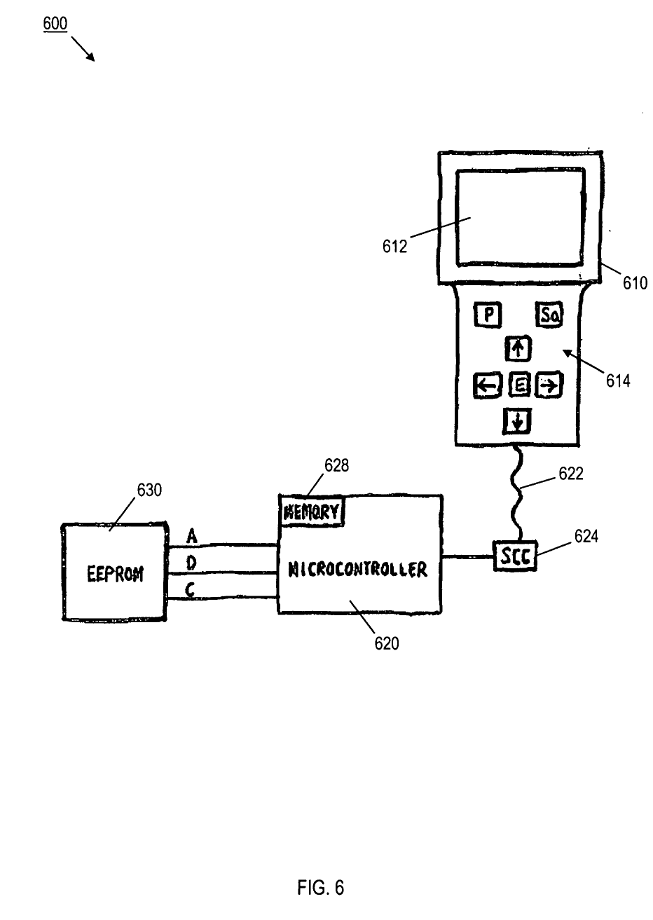

As shown in FIG. 2, actuators are provided for controlling movement of the various user support surfaces, in response to signals received from a main controller 620 (also shown in FIG. 6). The main controller 620 may communicate with one or more actuators via a wired (e.g., a bus) or wireless (e.g., RF) connection 219. The main controller 620 may also communicate with a drive controller 214 to allow a user to control movement of the wheelchair 100. The drive controller 214 controls, for example, a left drive motor 216 and a right drive motor 218. Additionally, the main controller 620 may interface with other devices, for example, a remote input device 210 and a programmer device 212.

The user operates the power driven wheelchair 100 by user input and output (I/O) 205. The user I/O 205 may include, for example, joystick controller 130 mounted on the wheelchair 100. The user I/O 205 may also include a display screen integrated with the joystick controller 130, or a separate display device mounted on the wheelchair 100. Movement of the joystick controller 130 produces signals that are sent to the main controller 620 for further processing, e.g., to specify a drive direction of the wheelchair 100 or to move an actuator corresponding to a user support surface of the wheelchair 100. Additionally, various operational parameters may be displayed on the user I/O 205. For example, a current drive setting, an actuator being moved, etc. may be displayed on the user I/O 205. The user I/O 205 also allows the user to interact with menus displayed on the user I/O 205 to facilitate operation of the wheelchair and movement of the user support surfaces thereto.

Referring to FIG. 2, a tilt actuator 242 controls movement of the seat 112 and seat back 114 rotating, for example, relative to the chassis 140 while maintaining a constant angle between the seat 112 and the seat back 114. A recline actuator 244 controls movement of the seat back 114, for example, relative to the seat 112. A seat elevation actuator 246 controls up and down movement of the seat 112, for example, relative to the chassis 140. A right leg actuator 248 and a left leg actuator 250 control movement of the right leg 120 and the left leg 122, respectively, for example, relative to the seat frame 110.

Furthermore, a single actuator might function to control movement of several user support surfaces. For example, a tilt and recline actuator 240 can function to control the tilt movement of the seat 112 and seat back 114 and the recline movement of the seat back 114. A common leg actuator 252 can be used to control movement of the right leg 120 and the left leg 122 in unison. It will be appreciated that additional actuators may be provided, as needed, to control additional user support surfaces. Other actuators may be used as well. For example, back shear reduction actuator 230 and seat shear reduction actuator 232 are provided to reduce the movement of the user relative to the user support surfaces (i.e., the shear) during movement of one or more of the user support surfaces.

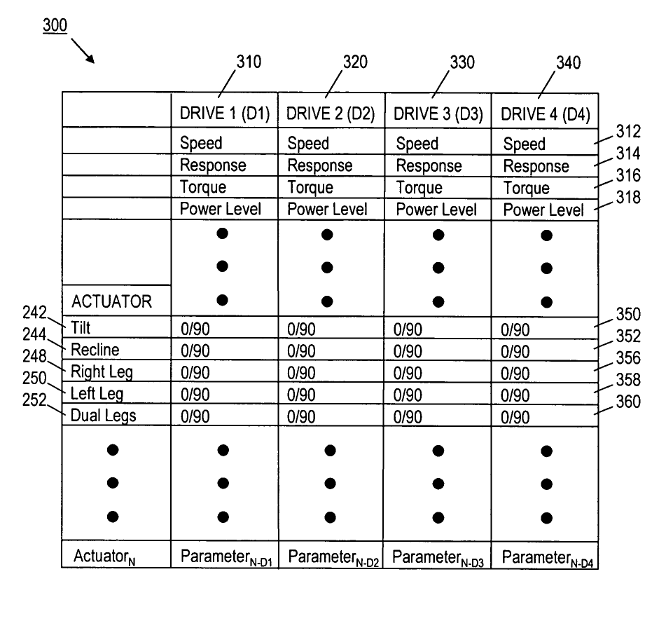

Parameters for one or more of these actuators may be stored in memory as parameters under one or more drive settings of a drive control program. Alternatively, the parameters could be stored in memory independently of any drive settings or drive control program. According to an exemplary implementation, as shown in FIG. 3, four drive settings (D1 310, D2 320, D3 330 and D4 340) corresponding to four different modes of operation of the wheelchair are stored in memory 300 (e.g., non-volatile memory of a control system 600 of the wheelchair, such as EEPROM 630 of FIG. 6).

The drive control program includes drive control parameters, such as speed 312, response 314, torque 316 and power level 318, for each of the drive settings. A drive control parameter may or may not differ from one drive setting to another. Additional parameters may be stored under the different drive settings. For example, as shown in FIG. 3, minimum and maximum position values are stored for various actuators. These values represent a minimum position (e.g., minimum angle) and a maximum position (e.g., maximum angle) for each actuator under each drive setting. Alternatively, the minimum and maximum position values may be stored elsewhere or hardwired for the system.

By way of illustration, parameters 350 limit the tilt actuator 242 to a movement range of 0 to 90 degrees for drive settings D1, D2, D3 and D4; parameters 352 limit the recline actuator 244 to a movement range of 0 to 90 degrees for drive settings D1, D2, D3 and D4; parameters 356 limit the right leg actuator 248 to a movement range of 0 to 90 degrees for drive settings D1, D2, D3 and D4; parameters 358 limit the left leg actuator 250 to a movement range of 0 to 90 degrees for drive settings D1, D2, D3 and D4; and parameters 360 limit the common leg actuator 252 to a movement range of 0 to 90 degrees for drive settings D1, D2, D3 and D4. Other actuators, such as the seat elevation actuator 246, may have parameters expressed other than in degrees (e.g., in inches) to limit a movement range of the actuator. These actuator limits may be fixed, as they are often based on hardware considerations. Additionally, the parameters corresponding to a movement range of a particular actuator need not be the same for each drive setting.

According to an exemplary embodiment, a system for automating the positioning of a user support surface of a wheelchair is provided. In the system, additional parameters are associated with each actuator. Each of these parameters indicates a position to which the particular actuator is to move for the corresponding drive setting.

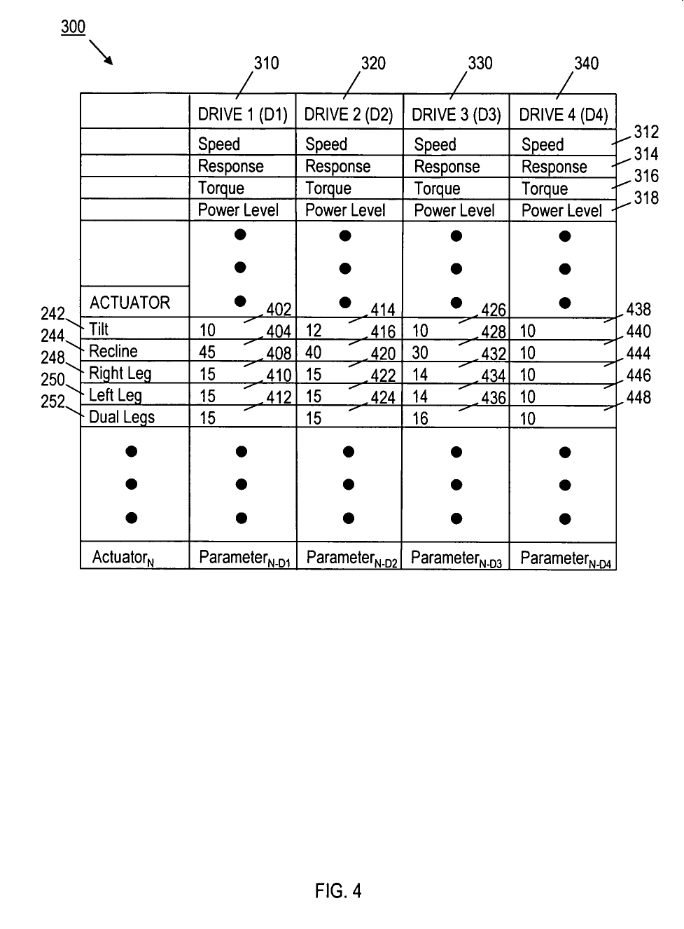

For example, as shown in FIG. 4, drive setting D1 310 includes position parameters 402, 404, 408, 410 and 412; drive setting D2 320 includes position parameters 414, 416, 420, 422 and 424; drive setting D3 330 includes position parameters 426, 428, 432, 434 and 436; and drive setting D4 340 includes position parameters 438, 440, 444, 446 and 448, which correspond to the tilt actuator 242, the recline actuator 244, the right leg actuator 248, the left leg actuator 250 and the common leg actuator 252, respectively, for each drive setting. By way of illustration, for drive setting D2 320, position parameter 416 indicates that the recline actuator 244 is to move to a position corresponding to an angle of 40 degrees. Movement of recline actuator 244 to such a position would cause the user support surface defined by the seat back 114 to move accordingly. These position parameters function as preset positions for the various user support surfaces, across the various drive settings. Accordingly, a user can cause a user support surface of the wheelchair to automatically move to a preset position by entering an appropriate command (e.g., by manipulating the joystick controller 130), which results in the actuator or actuators corresponding to the user support surface moving to a predefined position indicated by the position parameter associated with the command and the current drive setting.

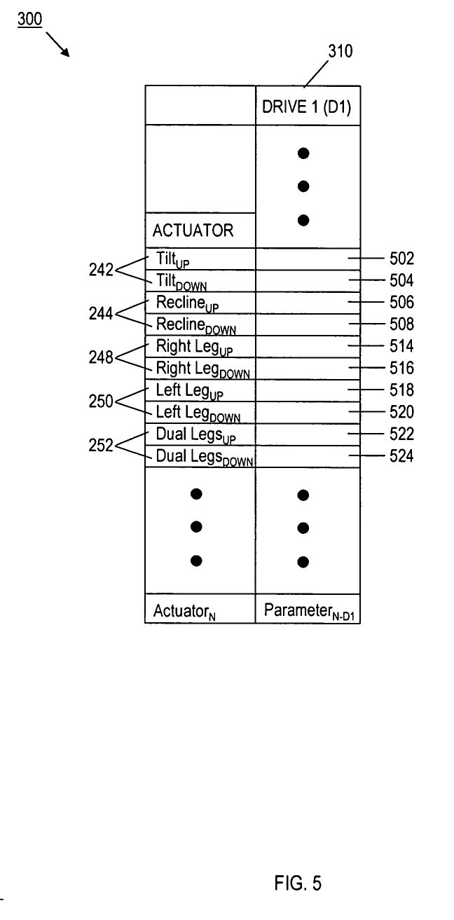

Additionally, as shown in FIG. 5, multiple position parameters may be defined for the same actuators in the same drive setting. For simplicity, only drive setting D1 310 is shown. In FIG. 5, up-angle position parameters 502, 506, 514, 518 and 522, which correspond to the tilt actuator 242, the recline actuator 244, the right leg actuator 248, the left leg actuator 250 and the common leg actuator 252, respectively, are associated with a left-drive command, e.g., moving the joystick left while the wheelchair is in an appropriate mode. Down-angle position parameters 504, 508, 516, 520 and 524, which correspond to the tilt actuator 242, the recline actuator 244, the right leg actuator 248, the left leg actuator 250 and the common leg actuator 252, respectively, are conversely associated with a right-drive command, e.g., moving the joystick right while the wheelchair is in an appropriate mode.

Accordingly, as described below, a user can enter the appropriate command to initiate the corresponding automatic positioning. For example, if the user enters the right-drive command, one or more selected actuators associated with the right-drive command are automatically positioned based on previously stored position parameters.

Next, setup of the position parameters will be described with reference to FIGS. 5 and 6. Preferably, but not necessarily, a technician (or other qualified individual) will ensure that the actuators to be programmed are properly installed and functioning. Using a programming device (e.g., programmer 212 in FIG. 2), the technician will then proceed to program the up-angle position parameter (e.g., parameter 502) and the down-angle position parameter (e.g., parameter 504) for an actuator (e.g., tilt actuator 242) and a drive setting (e.g., D1 310). The technician can continue to program parameters for other actuators and other drive settings.

Programming of the parameters may be carried out in accordance with the method and apparatus disclosed in U.S. Non-Provisional patent application Ser. No. ______ entitled METHOD AND APPARATUS FOR PROGRAMMING PARAMETERS OF A POWER DRIVEN WHEELCHAIR FOR A PLURALITY OF DRIVE SETTINGS and filed on ______, which is incorporated herein by reference in its entirety.

An exemplary programming device is illustrated in FIG. 6. As shown in FIG. 6, an external, hand held programmer unit 610 may be coupled to a control system 600 of the power driven wheelchair 100 and comprises a display screen 612 which may be a liquid crystal display (LCD), for example, and a plurality of pushbuttons 614 for use in selecting the desired drive setting and actuator and entering the position parameter settings, like up-angle and down-angle position values, for example, by interacting with the image on the display screen 612 as will become better understood from the description below. More specifically, the pushbuttons 614 may include a Power I/O (P), Save (Sa), Enter (E), left arrow, right arrow, up arrow and down arrow pushbuttons.

In the present exemplary embodiment, the remote programmer unit 610 communicates with a main controller 620 of the control system 600 via serially coded signals over lines 622. The main controller 620 may include a programmed microcontroller. The serial lines 622 may be coupled to the microcontroller 620 through a serial communication controller (SCC) 624. The tasks of the SCC 624 include setting the protocol, performing serial/parallel translations, checking for errors in transmission, and managing the traffic for the serial communication between the remote programmer unit 610 and the main controller 620.

The microcontroller 620 may include an internal memory 628 which may be of the random access (RAM) or scratch pad type, for example, and is coupled to an electrically erasable programmable read only memory (EEPROM) 630 over address (A), data (D) and control (C) lines. While the memory 628 is shown internal to the microcontroller 620, it is understood that a portion or all of the memory 628 may just as well be external to the microcontroller 620. Generally, when powered up, the controller 620 will boot up under program control and may access the preset parameters and relationships stored in the EEPROM 630 and store them temporarily to the scratch pad memory 628 for interaction with the remote programmer unit 610 and operation of the wheelchair. It is understood that when power is removed, the stored data of the RAM 628 will be lost. The EEPROM 630, however, will retain the data of its memory without power. Other non-volatile memory may be used in addition to or instead of EEPROM, such as various removable non-volatile memory (e.g., SD, CF, MS, etc.) coupled via an appropriate connector.

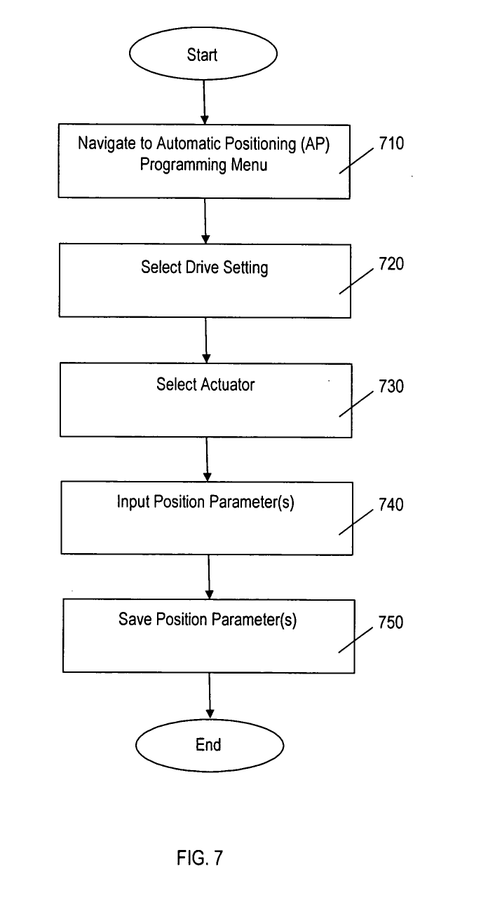

As indicated above, the microcontroller 620 is programmed to interact with the remote programmer unit 610 via signal lines 622 and SCC 624 for entry of the parameter values or settings and for the display thereof. The flowchart of FIG. 7 illustrates a method of programming position parameters for automatic positioning (AP) into a memory (e.g., EEPROM 630), using a programming device (e.g., programmer unit 610), to automate the positioning of user support surfaces of a wheelchair, according to an exemplary embodiment. The steps illustrated in FIG. 7 need not necessarily be performed in the order shown.

In FIG. 7, once the programmer unit 610 is connected to the control system 600 of a wheelchair, the technician navigates to the appropriate menu (i.e., an AP programming menu) for programming the position parameters, in step 710. Menus and other navigational aids (textual and/or graphical) may be displayed on the display screen 612 of the programmer unit 610. From the menu, the technician selects the drive setting to be programmed, in step 720.

Then, the technician selects the device (i.e., a specific actuator), associated with the selected drive setting, to be programmed, in step 730. For example, a list of available actuators may be displayed on the display screen 612, so that the technician can select the actuator from the displayed list. The selected actuator may be capable of accepting a plurality of position parameters, for example, up-angle and down-angle position parameters. In this case, step 730 may further include selecting a parameter number to program. Optionally, the different parameter numbers are associated with different commands. For example, the up-angle position parameter for an actuator may be associated with a left-drive command, so that the user can initiate automatic positioning of the actuator according to the up-angle position parameter by inputting the left-drive command. Similarly, the down-angle position parameter for an actuator may be associated with a right-drive command, so that the user can initiate automatic positioning of the actuator according to the down-angle position parameter by inputting the right-drive command.

Optionally, if the different parameter numbers are associated with different commands, the parameter numbers (and/or the parameter values) may be displayed on a display screen of the controller 130 or a separate display device, along with information on a command for initiating automatic positioning for each of the different parameter numbers. The information on a command may be abbreviated, iconic, etc. For example, displaying a left arrow on the display screen of the controller 130 or the separate display device next to a parameter number of 02 could be used to inform the user that a left-drive command has been associated with the position parameter numbered 02 for the selected actuator.

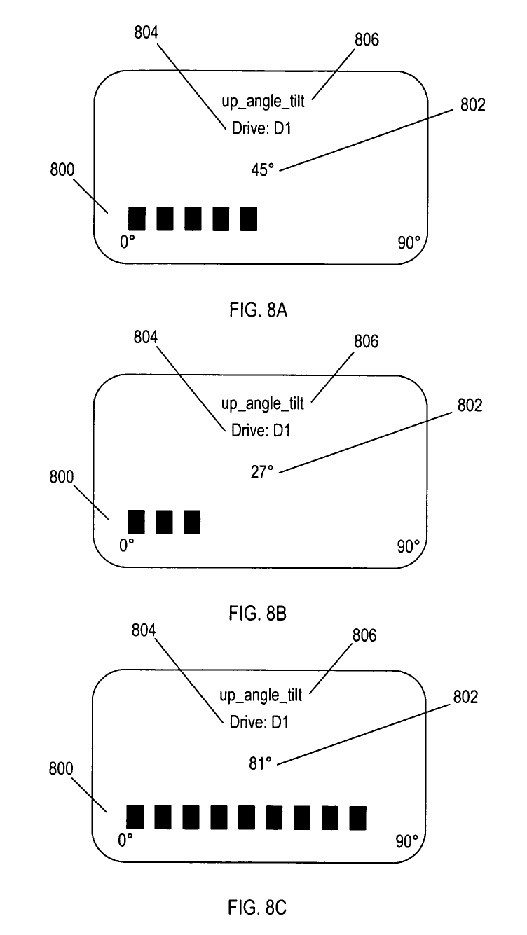

In step 740, the technician inputs the parameter value for the selected actuator. For inputting the parameter value, a graphic bar 800, as shown in FIGS. 8A-8C, may be displayed on the display screen 612 of the programmer unit 610. The numerical range associated with the graphic bar 800 may correspond to the numerical range of valid values for the parameter. In FIGS. 8A-8C, the graphic bar 80 represents the numerical range of 0 degrees to 90 degrees. As shown in FIG. 8A, the graphic bar 800, for example, initially displays the current value of the parameter to be programmed or a default value 802, here 45 degrees. Additional information may be displayed on the display screen 612, such as the drive setting 804 selected in step 720 and the actuator/parameter 806 to be programmed selected in step 730. More or less information may be displayed depending, for example, on a size of the display screen 612.

By manipulating the pushbuttons 614, the technician may decrease the parameter from the default value 802 (e.g., 45 degrees) to a desired lower value (e.g., 27 degrees), as illustrated in FIG. 8B, or increase the default value 802 (e.g., 45 degrees) to a desired higher value (e.g., 81 degrees), as illustrated in FIG. 8C. As one example, the programmer unit 610 and the main controller 620 cooperate so the technician can push the left arrow pushbutton to decrease the parameter value and the right arrow pushbutton to increase the parameter value.

In step 750, once the desired value is input for the position parameter, the position parameter is saved. As one example, the technician can push the Sa (save) pushbutton on the programmer unit 610 to save the input parameter value to memory. Preferably, but not necessarily, the input parameter value is stored in non-volatile memory. By repeating the steps shown in FIG. 7, the technician can save position values for the various actuators, spanning a plurality of drive settings.

It will be appreciated that devices other than the external programmer unit 610 could be used to program the position parameters. As one example, a touchpad controller used to control movement of the wheelchair could also be used to program the position parameters. In such a case, it may be desirable to require some form of authentication prior to programming in order to prevent unauthorized individuals from performing the programming.

It will further be appreciated that a plurality of position parameters can be programmed for each of the actuators. Accordingly, the position parameters optionally may be the same for each of the drive settings. As an example, if an actuator (e.g., recline actuator 244) is programmed to store 4 different position values, these position values are the same for each of the drive settings (e.g., D1 310, D2 320, D3 330 and D4 340). In this manner, regardless of the drive setting that a user is currently operating in, the user could access the four different preset positions, without having to change drive settings.

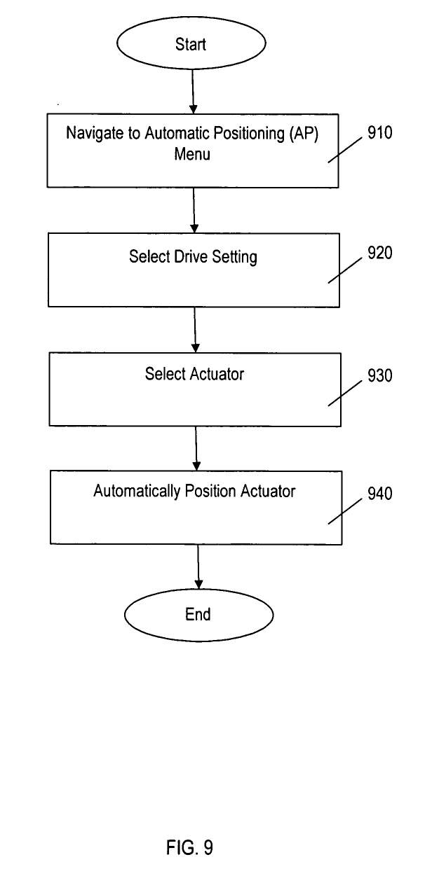

Once position parameters have been programmed into the system (e.g., by a technician, as described above), a wheelchair user can access those parameters to cause a user support surface of the wheelchair to automatically move to the position corresponding to the position parameter. The flowchart of FIG. 9 illustrates a method of automatically positioning a user support surface of a wheelchair, according to an exemplary embodiment. The steps illustrated in FIG. 9 need not necessarily be performed in the order shown.

As shown in FIG. 9, the user of the wheelchair navigates to an automatic positioning (AP) menu, in step 910. The user navigates to the AP menu using a controller 130 of the power driven wheelchair and, if the controller 130 does not have an integrated display screen, a separate display device. Menus and other navigational aids (textual and/or graphical) may be displayed on the display screen of controller 130 or the display device. From the menu, the user selects the drive setting having the desired preset position, in step 920. If the desired drive setting is already set, then this step can be omitted. Furthermore, it may be possible to set the drive setting without using the menu (e.g., through a switch).

Then, the user selects the actuator to be positioned automatically, in step 930. As a result, the selected actuator is automatically moved to the position corresponding to the previously programmed position parameter for the selected actuator and drive setting, in step 940. If different position parameters are associated with the selected actuator, the user may be required to select among the different positions using the controller 130 (e.g., by inputting a left drive command for a first parameter and a right drive command for a second parameter).

As one example, if the user selects the drive setting D3 330 and the recline actuator 244, in steps 920 and 930, then the recline actuator 244 is automatically moved to the preset position corresponding to the recline actuator 244 and drive setting D3 330, which results in the seat back 114 being automatically positioned to the previously programmed position. In this manner, the user is able to position a user support surface of a power driven wheelchair easily, accurately and consistently.

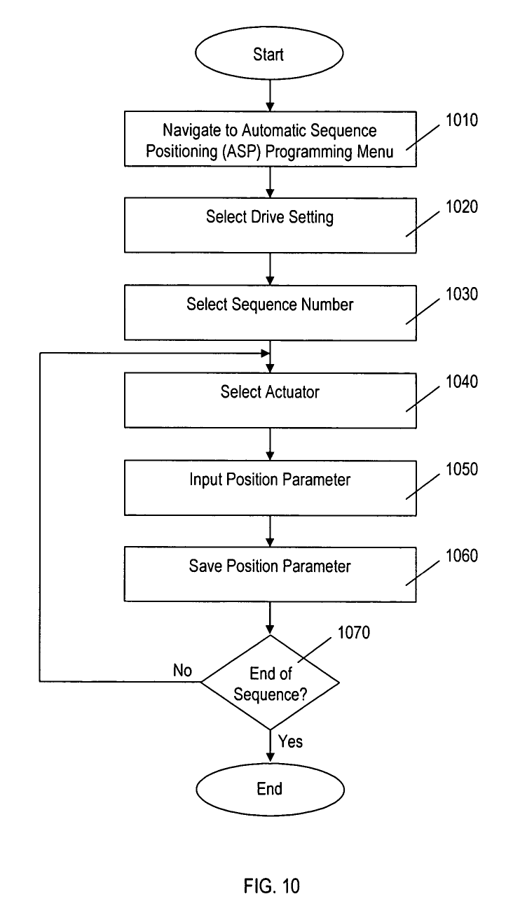

The flowchart of FIG. 10 illustrates a method of programming position parameters for automatic sequence positioning (ASP) into a memory (e.g., EEPROM 630), using a programming device (e.g., programmer unit 610), to automate the positioning of a sequence of user support surfaces of a wheelchair, according to an exemplary embodiment. The steps illustrated in FIG. 10 need not necessarily be performed in the order shown.

In FIG. 10, once the programmer unit 610 is connected to the control system 600 of a wheelchair, a technician navigates to the appropriate menu (i.e., an ASP programming menu) for programming the sequence of position parameters, in step 1010. Menus and other navigational aids (textual and/or graphical) may be displayed on the display screen 612 of the programmer unit 610. From the menu, the technician selects the drive setting to be programmed, in step 1020. Preferably, but not necessarily, multiple sequences can be programmed for each drive setting. In this case, the technician selects the sequence number to be programmed for the selected drive setting, in step 1030. Otherwise, this step can be omitted. Each of the different sequences (e.g., sequence numbers) may be associated with a different command. For example, a first sequence may be associated with a left-drive command, so that the user can initiate automatic positioning of the actuators according to the first sequence by inputting the left-drive command. Similarly, a second sequence may be associated with a right-drive command, so that the user can initiate automatic positioning of the actuators according to the second sequence, by inputting the right-drive command. In another embodiment, only two sequences may be programmed for each drive setting, i.e., a sequence associated with a left-drive command and a sequence associated with a right-drive command.

Optionally, if the different sequence numbers are associated with different commands, the sequence numbers (and/or the parameter values for the sequence) may be displayed on a display screen of the controller 130 or a separate display device, along with information on a command for initiating automatic positioning for each of the different sequence numbers. The information on a command may be abbreviated, iconic, etc. For example, displaying a right arrow on the display screen of the controller 130 or the separate display device next to a sequence number of 03 could be used to inform the user that a right-drive command has been associated with the sequence numbered 03 for the selected drive setting.

Then, the technician selects a first device (i.e., a specific actuator) for the sequence to be programmed, in step 1040. For example, a list of available actuators may be displayed on the display screen 612, so that the technician can select the actuator from the displayed list. In step 1050, the technician uses the programmer unit 610 to input a parameter value for the selected actuator. As noted above, FIGS. 8A-8C illustrate and the accompanying text describes an exemplary technique for inputting parameter values. In step 1060, once the desired value is input for the position parameter, the position parameter is saved. As one example, the technician can push the Sa (save) pushbutton on the programmer unit 610 to save the input parameter value to memory. Preferably, but not necessarily, the input parameter value is stored in non-volatile memory.

Next, it is determined whether the technician is finished defining the sequence, in step 1070. For example, “Sequence finished?” may be displayed on the display screen 612 of the programmer unit, wherein the technician can use the pushbuttons 614 to indicate yes or no. If the technician indicates that the sequence is finished (“Yes” in step 1070), then programming of the automatic positioning sequence is ended.

If the technician indicates that the sequence is unfinished (“No” in step 1070), then the control flow returns to step 1040 and programming of the automatic positioning sequence continues. In this way, the technician can program multiple preset positions that are associated with one another and will occur in a specified sequence.

It will be appreciated that devices other than the external programmer unit 610 could be used to program the position parameters. As one example, a touchpad controller used to control movement of the wheelchair could also be used to program the position parameters. In such a case, it may be desirable to require some form of authentication prior to programming in order to prevent unauthorized individuals from performing the programming.

Since a plurality of sequences can be programmed for each of the drive settings, the sequences optionally may be the same for each of the drive settings. As an example, if four different sequences are programmed for drive setting D1 310, then the same four sequences are programmed for drive settings D2 320, D3 330 and D4 340. In this manner, regardless of the drive setting that a user is currently operating in, the user could access the four different sequences, without having to change drive settings.

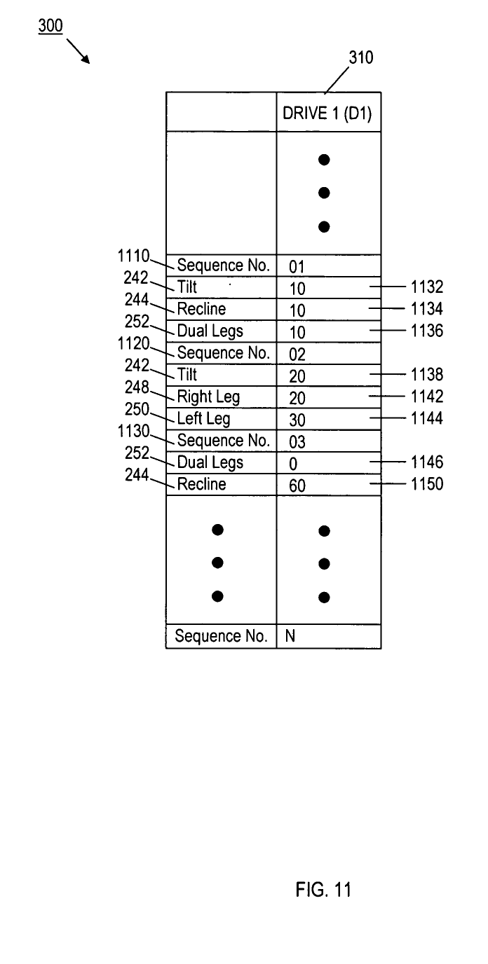

FIG. 11 is a diagram illustrating exemplary sequences of position parameters for a drive setting D1 310, as stored in a memory (e.g., EEPROM 630). As shown in FIG. 11, a sequence includes a sequence number and position parameters for a sequence of actuators.

For example, in FIG. 11, a first sequence 1110 has sequence number 01 and includes position values 1132, 1134 and 1136 for the sequential positioning of actuators 242, 244 and 252, respectively. A second sequence 1120 has sequence number 02 and includes position values 1138, 1142 and 1144 for the sequential positioning of actuators 242, 248 and 250, respectively. A third sequence 1130 has sequence number 03 and includes position values 1146 and 1150 for the sequential positioning of actuators 252 and 244, respectively.

These different sequences may correspond to different positions of the user support surfaces of the wheelchair for different purposes. For example, the first sequence 1110 may correspond to a position of the seat 112, the seat back 114 and the legs 120, 122, which facilitates loading of the wheelchair into a van. The second sequence 1120 may correspond to a position of the seat 112, the seat back 114 and the legs 120, 122, which facilitates transfer of the user from the wheelchair to his or her bed. The third sequence 1130 may correspond to a position of the seat 112, the seat back 114 and the legs 120, 122, which facilitates transfer of the user from the wheelchair to a car seat.

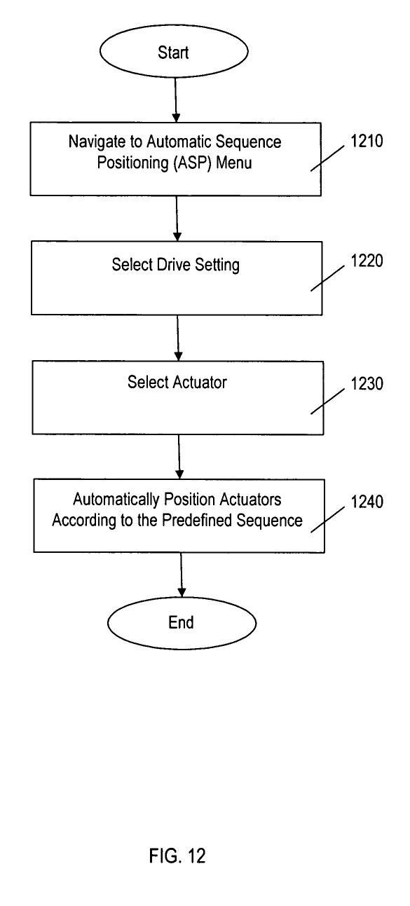

Once a sequence has been programmed into the system (e.g., by a technician, as described above), a wheelchair user can access the sequence to cause user support surfaces of the wheelchair to automatically move to the positions corresponding to the position parameters defined in the sequence. The flowchart of FIG. 12 illustrates a method of automatically positioning user support surfaces of a wheelchair in a predefined sequence, according to an exemplary embodiment. The steps illustrated in FIG. 12 need not necessarily be performed in the order shown.

As shown in FIG. 12, the user of the wheelchair navigates to an automatic sequence positioning (ASP) menu, in step 1210. The user navigates to the ASP menu using a controller 130 of the power driven wheelchair and, if the controller 130 does not have an integrated display screen, a separate display device. Menus and other navigational aids (textual and/or graphical) may be displayed on the display screen of controller 130 or the display device. From the menu, the user selects the drive setting having the desired preset sequence, in step 1220. If the desired drive setting is already set, then this step can be skipped. Furthermore, it may be possible to set the drive setting without using the menu (e.g., through a switch).

Then, the user selects the sequence to be activated, in step 1230. As a result, the selected sequence begins executing, in step 1240. Specifically, the first actuator in the sequence is automatically moved to the position corresponding to the previously programmed position parameter for this actuator in the selected sequence and drive setting. Once the first actuator in the sequence is moved to the preset position, the next actuator in the sequence is automatically moved to the position corresponding to the previously programmed position parameter for this actuator in the selected sequence and drive setting. This process repeats for each actuator in the sequence until all of the actuators have been moved to their respective final preset positions, thus ending the sequence. In this manner, the user is able to position the various user support surfaces of a power drive wheelchair easily, accurately and consistently.

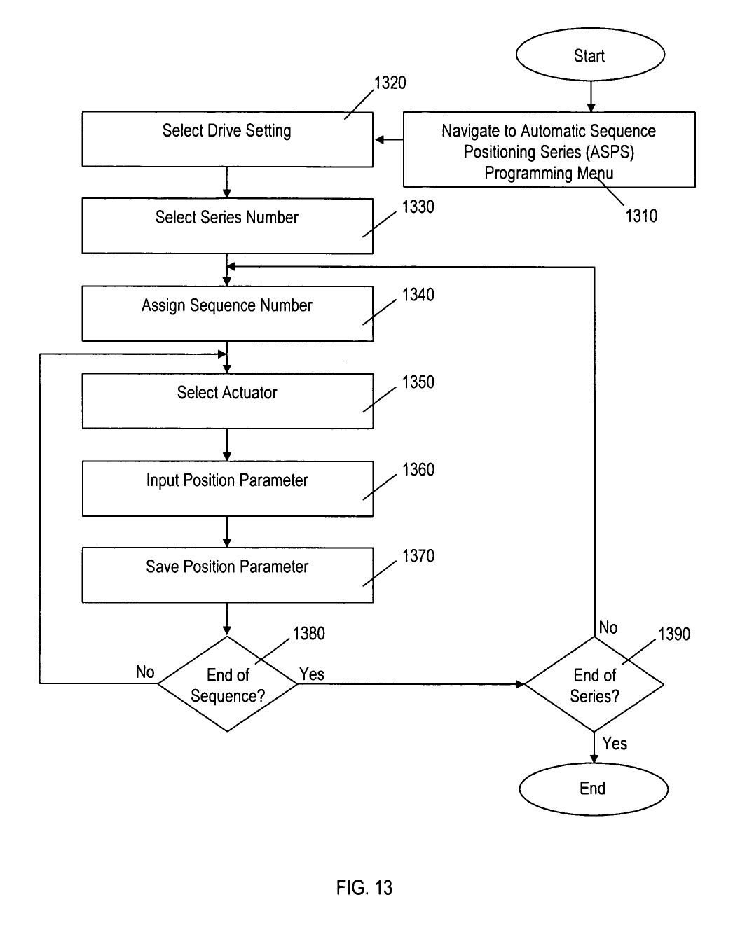

The flowchart of FIG. 13 illustrates a method of programming position parameters for an automatic sequence positioning series (ASPS) into a memory (e.g., EEPROM 630), using a programming device (e.g., programmer unit 610), to automate the positioning of a series of sequences of user support surfaces of a wheelchair, according to an exemplary embodiment. The steps illustrated in FIG. 13 need not necessarily be performed in the order shown.

In FIG. 13, once the programmer unit 610 is connected to the control system 600 of a wheelchair, a technician navigates to the appropriate menu (i.e., an ASPS programming menu) for programming the series of sequences of position parameters, in step 1310. Menus and other navigational aids (textual and/or graphical) may be displayed on the display screen 612 of the programmer unit 610. From the menu, the technician selects the drive setting to be programmed, in step 1320. Preferably, but not necessarily, multiple series can be programmed for each drive setting. In this case, the technician selects the series number to be programmed for the selected drive setting, in step 1330. Otherwise, this step can be omitted.

Next, a first sequence number is assigned for the series being programmed. As one example, a variable value representing a sequence counter can be reset to 0 in step 1330 and incremented by 1 in step 1340. In this manner, each time step 1340 is performed, the sequence counter will be incremented by 1.

After the first sequence of the series is assigned sequence number 1 in step 1340, the technician selects a first device (i.e., a specific actuator) for the sequence to be programmed, in step 1350. For example, a list of available actuators may be displayed on the display screen 612, so that the technician can select the actuator from the displayed list. In step 1360, the technician uses the programmer unit 610 to input a parameter value for the selected actuator. As noted above, FIGS. 8A-8C illustrate and the accompanying text describes an exemplary technique for inputting parameter values. In step 1370, once the desired value is input for the position parameter, the position parameter is saved. As one example, the technician can push the Sa (save) pushbutton on the programmer unit 610 to save the input parameter value.

Next, it is determined whether the technician is finished defining the sequence, in step 1380. For example, “Sequence finished?” may be displayed on the display screen 612 of the programmer unit, wherein the technician can use the pushbuttons 614 to indicate yes or no. If the technician indicates that the sequence is unfinished (“No” in step 1380), then the control flow returns to step 1350 and programming of the sequence continues. In this way, the technician can program multiple preset positions that are associated with one another and will occur in a specified sequence.

If the technician indicates that the sequence is finished (“Yes” in step 1380), then the control flow goes to step 1390. In step 1390, it is determined whether the technician is finished defining the series (of sequences). For example, “Series finished?” may be displayed on the display screen 612 of the programmer unit, wherein the technician can use the pushbuttons 614 to indicate yes or no.

If the technician indicates that the series is finished (“Yes” in step 1390), then the programming of the automatic positioning sequence series is ended. If the technician indicates that the series is unfinished (“No” in step 1390), then the control flow returns to step 1340, wherein a new sequence number is assigned to the next sequence in the series, and programming of the series continues.

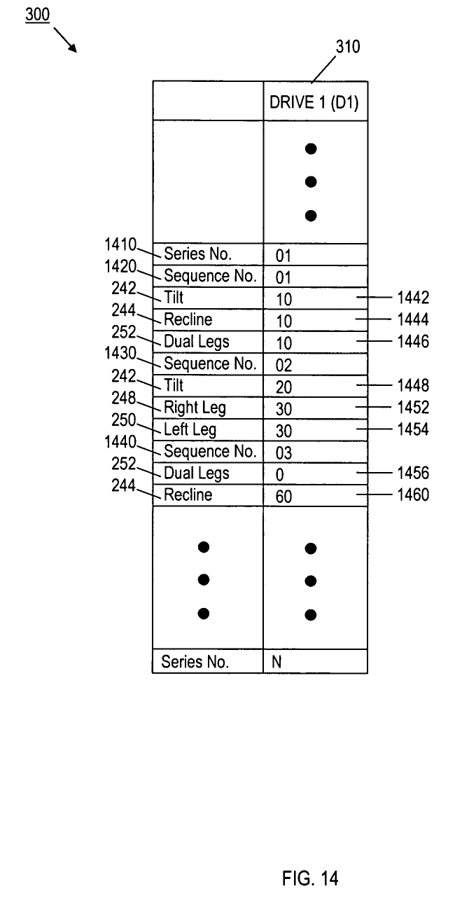

FIG. 14 is a diagram illustrating an exemplary series of sequences of position parameters for a drive setting D1 310, as stored in a memory (e.g., EEPROM 630). As shown in FIG. 14, a series includes a series number and one or more sequences, wherein each sequence includes a sequence number and position parameters for a sequence of actuators.

For example, in FIG. 14, a first series 1410 has series number 01 and includes three sequences 1420, 1430 and 1440. In the series 1410, a first sequence 1420 has sequence number 01 and includes position values 1442, 1444 and 1446 for the sequential positioning of actuators 242, 244 and 252, respectively. A second sequence 1430 has sequence number 02 and includes position values 1448, 1452 and 1454 for the sequential positioning of actuators 242, 248 and 250, respectively. A third sequence 1440 has sequence number 03 and includes position values 1456 and 1460 for the sequential positioning of actuators 252 and 244, respectively.

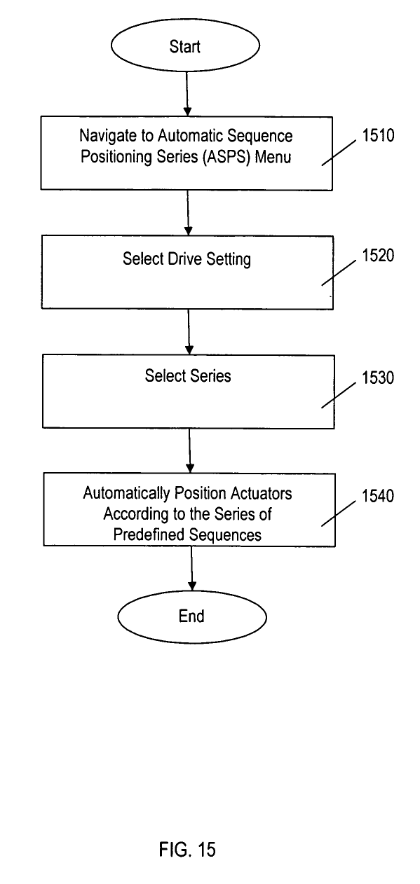

Once a series of sequences has been programmed into the system (e.g., by a technician, as described above), a wheelchair user can access the series to cause user support surfaces of the wheelchair to automatically move to the positions corresponding to the position parameters defined in the series of sequences. The flowchart of FIG. 15 illustrates a method of automatically positioning user support surfaces of a wheelchair through a series of predefined sequences, according to an exemplary embodiment. The steps illustrated in FIG. 15 need not necessarily be performed in the order shown.

As shown in FIG. 15, the user of the wheelchair navigates to an automatic sequence positioning series (ASPS) menu, in step 1510. The user navigates to the ASPS menu using a controller 130 of the power driven wheelchair and, if the controller 130 does not have an integrated display screen, a separate display device. Menus and other navigational aids (textual and/or graphical) may be displayed on the display screen of controller 130 or the display device. From the menu, the user selects the drive setting having the desired preset series, in step 1520. If the desired drive setting is already set, then this step can be skipped. Furthermore, it may be possible to set the drive setting without using the menu (e.g., through a switch).

Then, the user selects the series to be activated, in step 1530. If the desired series if already set or if a drive setting is limited to a single series, then this step can be skipped. As a result, the selected series begins executing, in step 1540. Specifically, for each sequence in the series, the actuators are sequentially moved to the positions corresponding to the previously programmed position parameters for the sequence. Once a first sequence completes, the next sequence in the series begins automatically. This process repeats for each sequence in the series until all of the sequences have completed, thus ending the series. In this manner, the user is readily able to initiate an automatic series of different positions of the various user support surfaces of a power drive wheelchair.

In another exemplary embodiment, the different sequences, comprising a series, may correspond to different positions of the user support surfaces of the wheelchair for therapeutic purposes. In particular, different positions prescribed to the user may be carried out by automatically positioning the user support surfaces of the wheelchair. For example, a first sequence may include automatically elevating the legs of the wheelchair to a predetermined position (e.g., to address a lower-extremity circulation issue of the user).

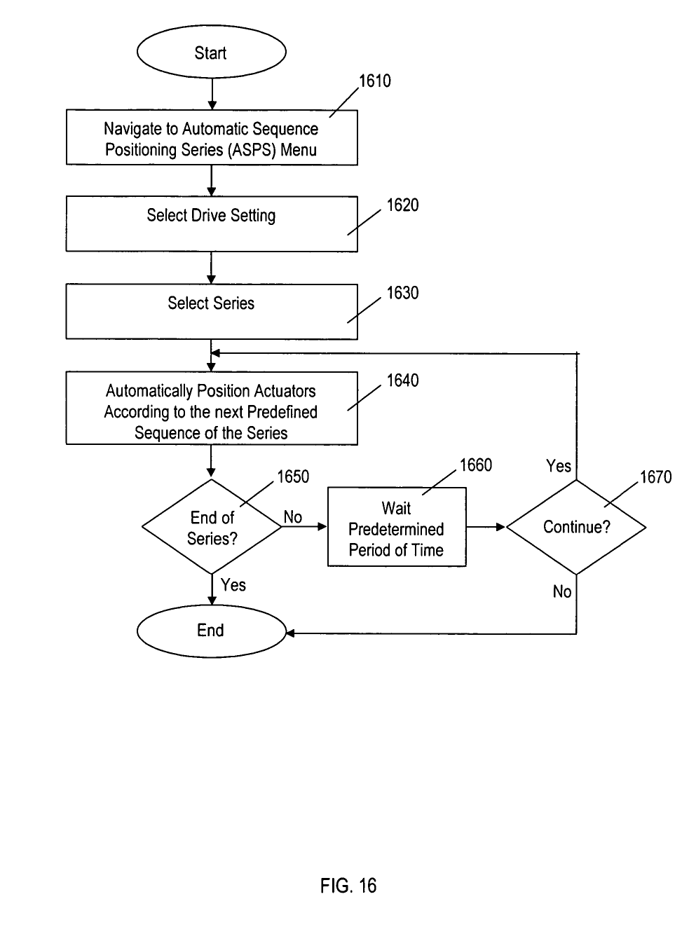

In this exemplary embodiment, the ASPS parameters are used to periodically reposition the user support surfaces of the wheelchair automatically. In particular, the flowchart of FIG. 16 illustrates a method of automatically positioning user support surfaces of a wheelchair through a series of predefined sequences, upon receiving user confirmation before beginning each sequence in the series. The steps illustrated in FIG. 16 need not necessarily be performed in the order shown.

As shown in FIG. 16, the user of the wheelchair navigates to an automatic sequence positioning series (ASPS) menu, in step 1610. The user navigates to the ASPS menu using a controller 130 of the power driven wheelchair and, if the controller 130 does not have an integrated display screen, a separate display device. Menus and other navigational aids (textual and/or graphical) may be displayed on the display screen of controller 130 or the display device. From the menu, the user selects the drive setting having the desired preset series, in step 1620. If the desired drive setting is already set, then this step can be omitted. Furthermore, it may be possible to set the drive setting without using the menu (e.g., through a switch).

Then, the user selects the series to be activated, in step 1630. If the desired series is already set or if a drive setting is limited to a single series, then this step can be skipped. As a result, a first sequence in the series begins executing, in step 1640. Specifically, the actuators are sequentially moved to the positions corresponding to the previously programmed position parameters for the sequence. Once the first sequence completes, it is determined whether the series has ended, in step 1650.

If it is determined in step 1650 that the series has ended, the automated positioning of the user support surfaces of the wheelchair ends. Otherwise, the method waits for a predetermined period of time, represented by step 1660, for example, 30 minutes. Preferably, but not necessarily, the predetermined period of time is a parameter set by the technician when programming the series (see FIG. 13).

After the predetermined period of time has passed, represented by step 1660, the user is prompted to confirm that he or she wishes to continue with the automated positioning of the user support surfaces of the wheelchair, i.e., whether the user wishes for the next sequence in the series to be executed, in step 1670. For example, “Continue?” may be displayed on a display screen of the controller 130 or a separate display device, wherein the user can use the controller 130 (or other input device) to indicate yes or no.

If the user indicates that he or she does not wish to continue with the series (“No” in step 1670), then the automated positioning of the user support surfaces of the wheelchair ends.

Otherwise, if the user indicates that he or she wishes to continue with the series (“Yes” in step 1670), then the control flow returns to step 1640, wherein a next sequence in the series begins executing. Specifically, the actuators are sequentially moved to the positions corresponding to the previously programmed position parameters for the sequence. The following processing (steps 1650, 1660 and 1670) is the same as described above and repeats until the series had ended or the user no longer wishes to continue to a next sequence in the series.

In this manner, the user is able to initiate a series of positions for the user support surfaces of the wheelchair. Each positioning of the user support surfaces (i.e., each sequence) is performed automatically and separated by a predetermined period of time. Optionally, the period of time between different sequences in a series can vary. Preferably, but not necessarily, user confirmation is required between each sequence or before each sequence begins. The different sequences in the series and the time interval between the sequences can be programmed to correspond to a prescribed routine, which may result in health benefits such as improved circulation, a reduced likelihood of bedsores, etc.

As an example, a series could be programmed for a user with a history of bedsores to reduce the likelihood of the user developing further bedsores. In general terms, a bedsore is an ulceration of tissue deprived of adequate blood supply by prolonged pressure. Upon initiation of the series by the user (or caregiver), the position of the user supports surfaces of the wheelchair are automatically moved to a first position, according to a first sequence of the series. After a predetermined period of time (e.g., 1 hour) has passed, and upon receipt of confirmation via the controller from the user to continue, the user support surfaces of the wheelchair are automatically moved to a second position, according to a second sequence of the series. If each sequence in the series is programmed to redistribute the user's weight in the wheelchair with respect to the user support surfaces, prolonged pressure on any one part of the user's body can be avoided, such that the likelihood of the user developing a bedsore is reduced.

Exemplary embodiments have been provided herein for purposes of illustration and are not intended to in any way be limiting. Indeed, additional advantages and modifications will readily appear to those skilled in the art. For example, the automatic positioning of actuators according to a sequence of position parameters can include positioning more than one actuator at a time. Accordingly, such departures may be made from the exemplary embodiments without departing from the spirit or scope of the applicants' general concept.

Furthermore, it will be clear to those of ordinary skill in the art that all of the methods described herein and set forth in the claims, as well as any and all combinations and permutations of the steps thereof, may be implemented in the form of and/or in combination with a power driven wheelchair or a controller for a power driven wheelchair.

We claim:

1. A method of automating movement of a user support surface of a power driven wheelchair to a predefined position, the method comprising:
storing data representing a predetermined position of the user support surface of the power driven wheelchair in a non-volatile memory; and
associating the data with a user input so that a user can input the user input to cause the user support surface of the power driven wheelchair to automatically move to the predetermined position.

2. The method of claim 1, further comprising associating the data with a drive setting of the power driven wheelchair.

3. The method of claim 1, further comprising, if the user input is detected, automatically moving the user support surface to the desired position based on the data.

4. The method of claim 1, wherein the data includes a number within a range representing a minimum position and a maximum position of the user support surface.

5. The method of claim 4, wherein the number is an angle associated with the support surface.

6. The method of claim 4, wherein the number is a distance associated with the support surface.

7. The method of claim 1, wherein the data is input using a programming device which interfaces with a control system of the power driven wheelchair.

8. The method of claim 1, wherein the user support surface is at least one of a seat, a seat back, an armrest, a leg and a footrest.

9. The method of claim 1, wherein the user input is a drive command.

10. The method of claim 1, wherein the non-volatile memory is mounted on the power driven wheelchair.

11. A method of automating movement of a plurality of user support surfaces of a power driven wheelchair to predefined positions, the method comprising:
storing data representing a predetermined position of each of the plurality of user support surfaces of the power driven wheelchair in a non-volatile memory; and
associating the data with a user input so that a user can input the user input to cause each of the plurality of user support surfaces of the power driven wheelchair to automatically move to the corresponding predetermined position.

12. The method of claim 11, further comprising, if the user input is detected, automatically moving each of the user surfaces to the corresponding desired position based on the data.

13. The method of claim 11, further comprising defining an order in which the user support surfaces are to be moved.

14. The method of claim 13, wherein the data includes the order in which the user support surfaces are to be moved.

15. The method of claim 13, further comprising, if the user input is detected, automatically moving each of the user surfaces, according to the order, to the corresponding desired position based on the data.

16. The method of claim 11, further comprising associating the data with a drive setting of the power driven wheelchair.

17. The method of claim 11, wherein the data includes a number for each of the plurality of user support surfaces, and the number is within a range representing a minimum position and a maximum position of the corresponding user support surface.

18. The method of claim 17, wherein at least one of the numbers is an angle associated with a corresponding user support surface.

19. The method of claim 17, wherein at least one of the numbers is a distance associated with a corresponding user support surface.

20. The method of claim 11, wherein the data is input using a programming device which interfaces with a control system of the power driven wheelchair.

21. The method of claim 11, wherein the user support surfaces include at least two of a seat, a seat back, an armrest, a leg and a footrest.

22. The method of claim 11, wherein the user input is a drive command.

23. The method of claim 11, wherein the non-volatile memory is mounted on the power driven wheelchair.

24. A method of automating movement of a plurality of user support surfaces of a power driven wheelchair to predefined positions, the method comprising:
storing first data representing a predetermined position of each of a first plurality of the user support surfaces of the power driven wheelchair in a non-volatile memory;
storing second data representing a predetermined position of each of a second plurality of the user support surfaces of the power driven wheelchair in the non-volatile memory; and
associating the first data and the second data with a user input so that a user can input the user input to cause the first plurality of the user support surfaces to automatically move to the corresponding predetermined positions and the second plurality of the user support surfaces to automatically move to the corresponding predetermined positions.

25. The method of claim 24, further comprising, if the user input is detected:
automatically moving each of the first plurality of the user support surfaces to the corresponding predetermined positions based on the first data; and
automatically moving each of the second plurality of the user support surfaces to the corresponding predetermined positions based on the second data.

26. The method of claim 24, further comprising:
defining a first order in which the first plurality of the user support surfaces are to be moved; and
defining a second order in which the second plurality of the user support surfaces are to be moved.

27. The method of claim 26, wherein the first data includes the first order and the second data includes the second order.

28. The method of claim 26, further comprising, if the user input is detected:
automatically moving each of the first plurality of the user support surfaces, according to the first order, to the corresponding predetermined positions, based on the first data; and
automatically moving each of the second plurality of the user support surfaces, according to the second order, to the corresponding predetermined positions, based on the second data.

29. The method of claim 24, further comprising defining an order in which the first data and the second data will be processed.

30. The method of claim 24, wherein the first plurality of the user support surfaces and the second plurality of the user support surfaces are the same user support surfaces.

31. The method of claim 26, further comprising the ordered steps of:
automatically moving each of the first plurality of the user support surfaces, according to the first order, to the corresponding predetermined positions, based on the first data;
waiting a predetermined period of time; and
automatically moving each of the second plurality of the user support surfaces, according to the second order, to the corresponding predetermined positions, based on the second data.

32. The method of claim 26, further comprising the ordered steps of:
automatically moving each of the first plurality of the user support surfaces, according to the first order, to the corresponding predetermined positions, based on the first data;
waiting a predetermined period of time;
determining if the user wants to continue; and
if the user wants to continue, automatically moving each of the second plurality of the user support surfaces, according to the second order, to the corresponding predetermined positions, based on the second data.

33. The method of claim 24, further comprising associating the first data and the second data with a drive setting of the power driven wheelchair.

34. The method of claim 24, wherein the first data and the second data are input using a programming device which interfaces with a control system of the power driven wheelchair.

35. The method of claim 24, wherein the user input is a drive command.

36. The method of claim 24, wherein the non-volatile memory is mounted on the power driven wheelchair.

37. A wheelchair comprising:
a user support surface connected to a frame of the wheelchair;
an actuator for moving the user support surface;
a controller;
a memory; and
a communication connection between the controller and the actuator; and
wherein data representing a predetermined position of the actuator corresponding to a position of the user support surface is associated with a user input and stored in the memory; and
wherein if the controller receives the user input, the controller uses the communication connection to cause the actuator automatically to move to the predetermined position stored in the memory to move the user support surface to a corresponding position.

38. A controller for controlling movement of an actuator to move a user support surface of a wheelchair, the controller comprising:
a processor; and
a memory; and
wherein the memory stores data representing a predetermined position of the actuator corresponding to a position of the user support surface and a user input associated with the predetermined position; and
wherein the processor generates a signal for causing the actuator automatically to move to the predetermined position to move the user support surface to a corresponding position, in response to detecting the user input.
